(19) United States
(12) Patent Application Publication
(10) Pub. No.: US 2018/0031841 A1
(43) Pub. Date: Feb. 1, 2018

(54) HEAD-MOUNTED DISPLAY

(71) Applicant: Coretronic Corporation, Hsin-Chu (TW)

(72) Inventors: Chi-Tang Hsieh, Hsin-Chu (TW); Chih-Hsien Tsai, Hsin-Chu (TW); Haw-Woei Pan, Hsin-Chu (TW)

(73) Assignee: Coretronic Corporation, Hsin-Chu (TW)

(21) Appl. No.: 15/659,640

(22) Filed: Jul. 26, 2017

(30) Foreign Application Priority Data
Jul. 28, 2016 (CN) 201610604870.9

(51) Int. Cl. G02B 27/01; G06F 1/16

(52) U.S. Cl. CPC G02B 27/0172; G02B 27/0176; G06F 1/1637; G06F 1/1684; G06T 19/006

(57) ABSTRACT

A head-mounted display including an apparatus body and an image display device is provided. The apparatus body includes a first part and a second part assembled to the first part. The image display device is disposed in the apparatus body, projects an image to a projection target, and includes an image output element, a plurality of lens elements, and an imaging element. The image output element outputs an image beam transmitted to the imaging element through the lens elements. The imaging element projects the image beam to the projection target to display the image. The image output element and the lens elements are disposed in the first part. The projection target is located on a reference plane, on which a projection of the image output element is above the projection target.

### CROSS-REFERENCE TO RELATED APPLICATION

This application claims the priority benefit of China application serial no. 201610604870.9, filed on Jul. 28, 2016. The entirety of the above-mentioned patent application is hereby incorporated by reference herein and made a part of this specification.

### BACKGROUND OF THE INVENTION

### Field of the Invention

The invention relates to a display, and particular relates to a head-mounted display.

### Description of Related Art

Near eye displays (NEDs) or head-mounted displays (HMDs) are currently considered to be wearable displays that are full of potential. The NEDs are divided into the augmented reality (AR)-type and virtual reality (VR)-type based on whether an image of the surroundings can also be seen in actual use. Virtual reality emphasizes the sense of reality in a virtual world, namely a wide field of view that exceeds the extreme of human eyes. Augmented reality, on the other hand, focuses on providing the best image quality under the premise of making an apparatus more light-weighted. Currently, the key to the development of optical technologies for AR-type head-mounted displays is how the crucial requirements, namely field of view (FOV), size, weight, and appearance, can be taken into consideration at the same time.

The information disclosed in this “Description of Related Art” section is only for enhancement understanding of the background of the invention and therefore it may contain information that does not form the prior art that is already known to a person of ordinary skill in the art. Furthermore, the information disclosed in this “Description of Related Art” section does not mean that one or more problems to be solved by one or more embodiments of the invention were acknowledged by a person of ordinary skill in the art.

### SUMMARY OF THE INVENTION

The invention provides a head-mounted display capable of expanding the user's field of view (FOV) and having a reduced size and weight.

The invention provides a head-mounted display that has a fashionable appearance and is comfortable to wear.

Other objects and advantages of the invention can be further illustrated by the technical features broadly embodied and described as follows.

In order to achieve one or a part of or all of the objects or other objects, an embodiment of the invention is directed to a head-mounted display including an apparatus body and an image display device. The apparatus body includes a first part and a second part connected to the first part. The image display device is disposed in the apparatus body. The image display device is configured to project an image to a projection target. The image display device includes an image output element, a plurality of lens elements, and an imaging element. The image output element outputs an image beam transmitted to the imaging element through the lens elements. The imaging element projects an image beam to the projection target by virtual image projection, so as to display the image. The image output element and the lens elements are disposed in the first part of the apparatus body. The projection target is located on a reference plane, and a projection of the image output element on the reference plane is above the projection target.

Based on the above, the embodiments of the invention at least have one of the following advantages or effects. In the image display device according to the embodiments of the invention, the respective optical elements are at least disposed dispersedly in the first part of the apparatus body. Therefore, the appearance of the head-mounted display is fashionable and the head-mounted display is comfortable to wear. Moreover, the head-mounted display is also capable of expanding the user's FOV and has a reduced size and weight.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view illustrating a head-mounted display according to an embodiment of the invention.

FIG. 2 is a schematic view illustrating a head-mounted display according to another embodiment of the invention.

FIG. 3 is a schematic view illustrating a head-mounted display according to another embodiment of the invention.

FIG. 4 is an optical schematic view illustrating an image display device according to an embodiment of the invention.

FIG. 5 is an optical schematic view illustrating a light source module according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

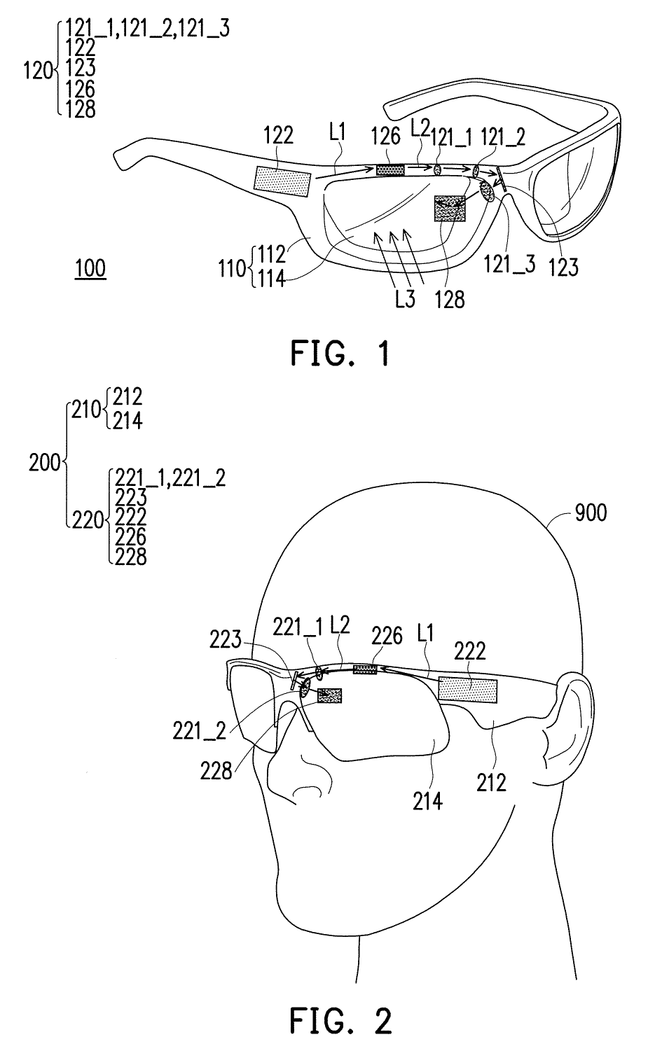

FIG. 1 is a schematic view illustrating a head-mounted display according to an embodiment of the invention. Referring to FIG. 1, a head-mounted display 100 of this embodiment includes an apparatus body 110 and an image display device 120. The apparatus body 110 includes a first part 112 and a second part 114 connected to the first part 112. In this embodiment, the apparatus body 110 includes spectacles, for example. However, the type and configuration of the spectacles shall not be construed as limitations on the invention. The first part 112 includes at least one of a frame, a holder, and a nose pad. In this embodiment, the frame, the holder, and the nose pad may be separately manufactured and then assembled by using a screw or a similar fixer, for example. In an embodiment, the frame, the holder, and the nose pad may also be integrally formed. The invention does not intend to impose a limitation on the type and configuration of the apparatus body 110. The second part 114 includes a lens. The number of the lens may be one or two or more, for example, and the lens may be assembled on the frame. In other embodiments, the first part 112 and the second part 114 may be integrally formed. For example, the first part 112 and the second part 114 may be integrally formed to be a goggle structure.

In this embodiment, the image display device 120 is disposed in the apparatus body 110. The image display device 120 is adapted to project an image to a projection target by virtual image projection. The projection target may be a user's eye (e.g., a projection target 800, the pupil of the user's eye, shown in FIG. 4), for example. In this embodiment, the image display device 120 includes a light source module 122, an image output element 126, an imaging element 128, a plurality of lens elements 121_1, 121_2, and 121_3, and a mirror element 123. In this embodiment, the lens elements 121_1, 121_2, and 121_3 are disposed on a transmitting path of an image beam L2 generated by the image output element 126. In addition, the lens elements 121_1, 121_2, and 121_3 are disposed between the image output element 126 and the imaging element 128. The mirror element 123 is disposed on the transmitting path of the image beam L2, and the mirror element 123 is disposed between the lens elements 121_2 and 121_3. In this embodiment, the light source module 122, the image output element 126, the lens elements 121_1, 121_2, and 121_3, and the mirror element 123 are disposed dispersedly in the first part 112 of the apparatus body 110. For example, the light source module 122 may be disposed at the holder. The image output element 126 may be disposed at the frame. The lens elements 121_1, 121_2, and 121_3 are disposed dispersedly in the first part 112 of the apparatus body 110. In this embodiment, the imaging element 128 is disposed in one of the first part 112 and the second part 114 of the apparatus body 110. For example, the imaging element 128 may be integrated onto the lens of the spectacles or located at an inner side of the lens and tightly attached to the lens. The imaging element 128 may be a transflective film or a splitter, for example, and may be formed on the lens by coating, for example. However, it should be understood that the invention is not limited thereto.

In this embodiment, the light source module 122 is configured to output the illumination beam L1 to the image output element 126. The image output element 126 modulates the illumination beam L1, and outputs the image beam L2 to the lens elements 121_1, 121_2, and 121_3 and the mirror element 123. The image beam L2 is transmitted to the imaging element 128 through the lens elements 121_1, 121_2, and 121_3 and the mirror element 123. The imaging element 128 then transmits the image beam L2 to the projection target 800 by virtual image projection, so as to display the image. In this embodiment, the mirror element 123 is configured to change the transmitting path of the image beam L2. For example, the mirror element 123 includes a reflective mirror configured to reflect the image beam L2 from the lens element 121_2 to the lens element 121_3 as well as changing the direction of the image beam L2. The number of the mirror element 123 in this embodiment is one, for example. However, based on the designs of different light paths, the number of the mirror element 123 may also be plural. The invention does not intend to impose a limitation on the number of the lens element 123.

In this embodiment, an ambient beam L3 passes through the second part 114 of the apparatus body 110 and is transmitted to the projection target, for example, such that the head-mounted display 100 is enabled to provide an augmented reality function. However, the method of dispersedly disposing the respective components of the image display device 120 in the embodiments of the invention may also be used in a head-mounted display for virtual reality or mixed reality (MR). The invention does not intend to impose a limitation on the applicability of the image display device 120.

In this embodiment, the image output element 126, the lens elements 121_1, 121_2, and 121_3, and the mirror element 123 are arranged along the first part 112 and the second part 114. For example, in this embodiment, an area where the image output element 126, the lens elements 121_1, 121_2, and 121_3, and the mirror element 123 are arranged is near a position of the user's nose. The position is where the first part 112 and the second part 114 are connected. In this embodiment, the illumination beam L1 is emitted by the light source module 122. After passing through the image output element 126, the illumination beam L1 becomes a beam carrying image information (i.e., the image beam L2). Then, the image beam L2 is transmitted into the user's eye after passing through the lens elements 121_1, 121_2, and 121_3, the mirror element 123, and the imaging element 128, and is focused on the retina by the crystalline lens (as a virtual image, for example) and forms an image.

However, it should be understood that the invention does not intend to impose a limitation on the type and configuration of the apparatus body (e.g., spectacles). FIG. 2 is a schematic view illustrating a head-mounted display according to another embodiment of the invention. Referring to FIGS. 1 and 2, a head-mounted display 200 of this embodiment is similar to the head-mounted display 100 in the embodiment shown in FIG. 1. The difference therebetween mainly lies in the configuration of an apparatus body 210 and the number of lens elements. For example, in this embodiment, a first part 212 of the apparatus body 210 does not completely enclose the edge of a second part 214. In this embodiment, the number of lens elements is 2, and the lens elements are respectively disposed on the transmitting path of the image beam L2 and between an image output element 226 and a mirror element 223 and between the mirror element 223 and an imaging element 228.

In this embodiment, the projection target is located on a reference plane, and a projection of the image output element 226 on the reference plane is above the projection target. For example, the projection target is the eye of a user 900, and the reference plane may be a general surface of the face of the user 900. In this embodiment, the projection of the image output element 226 on the surface of the face of the user 900 is located above the eye and near the eyebrow of the user 900. In other words, the projection of the image output element 226 on the reference plane is above the projection target. In this embodiment, the lens elements 221_1 and 221_2 are located on an inner side of the eye and are close to the nasal bridge while away from the ear.

In this embodiment, with the user 900 as reference, a light source module 222 is disposed on a left side of the user 900. A traveling direction of a light path is from left to right and then back to left. Namely, the image beam L2 is transmitted from the user's 900 eyebrow to his/her nasal bridge, and then transmitted from the nasal bridge to the eye. Moreover, in this embodiment, the imaging element 228 may be integrated onto and combined together with the lens or, as shown in FIG. 1, disposed at the inner side of the lens and tightly attached to the lens. In this embodiment, a light source module 310 is disposed at the holder of the spectacles, for example, as shown in FIGS. 1 to 3. However, the invention does not intend to impose a limitation on a location of the light source module 310. In this embodiment, based on practical needs, the light source module 310 may also be disposed at the frame or other appropriate locations.

Besides, the descriptions of the embodiment shown in FIG. 1 have provided sufficient teaching, suggestions, and explanations for embodiment concerning the locations and operations of the respective components in the head-mounted display 200 of this embodiment. Thus, details in these regards will not be reiterated below.

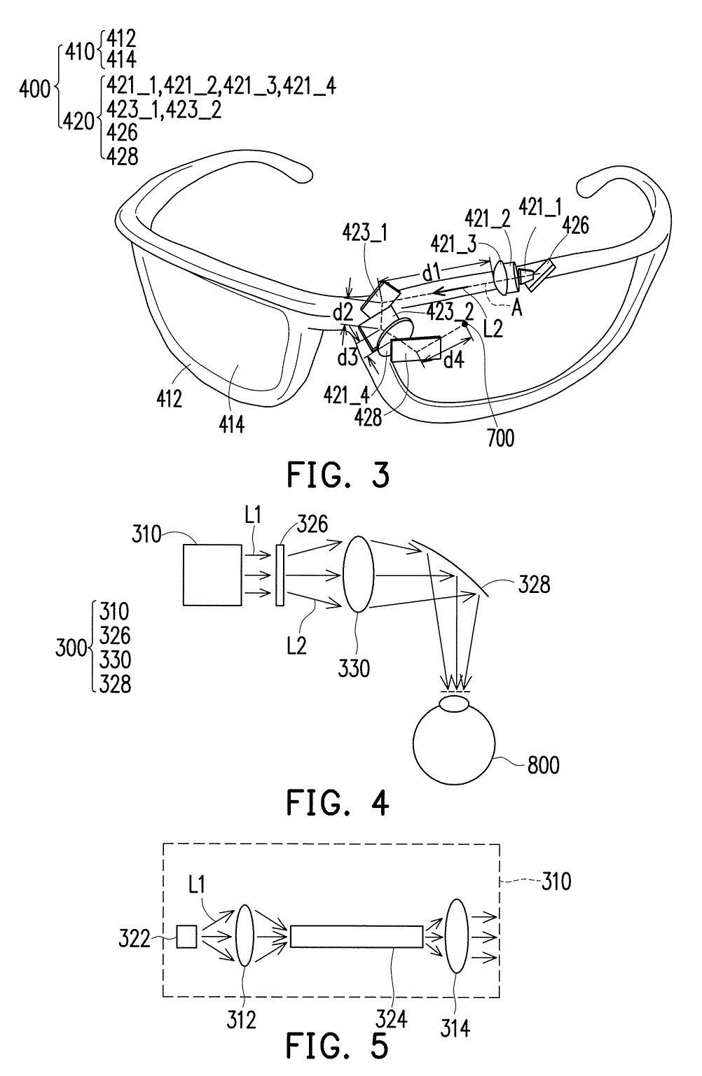

FIG. 3 is a schematic view illustrating a head-mounted display according to another embodiment of the invention. Referring to FIGS. 1 and 3, a head-mounted display 400 of this embodiment is similar to the head-mounted display 100 in the embodiment shown in FIG. 1. The difference therebetween mainly lies in the configuration of an apparatus body 410, the number of lens elements, and the number of mirror elements, for example. Besides, for a concise description, the light source module is not shown in FIG. 3.

Specifically, in this embodiment, there are four lens elements, namely lens elements 421_1, 421_2, 421_3, and 421_4. The lens elements 421_1, 421_2, and 421_3 are disposed on the transmitting path of the image beam L2 and located between an image output element 426 and a mirror element 423_1. The lens element 421_4 is disposed on the transmitting path of the image beam L2 and located between a mirror element 423_2 and an imaging element 428. The imaging element 428 is disposed in a first part 412 and near the nose pad, for example. In this embodiment, there are two mirror elements, namely the mirror elements 423_1 and 423_2. The mirror elements 423_1 and 423_2 are disposed between the lens element 421_3 and the lens element 421_4 on the transmitting path of the image beam L2.

In this embodiment, a distance between the lens element 421_1 and the mirror element 423_1 on an optical axis A is d1, a distance between the mirror element 423_1 and the mirror element 423_2 on the optical axis A is d2, a distance between the mirror element 423_2 and the lens element 421_4 on the optical axis A is d3, and a distance between the imaging element 428 and a projection target 700 is d4. In this embodiment, a ratio of a total of the distances d1, d2, and d3 to the distance d4 may be in a range from 2 to 2.5, and such ratio may facilitate an imaging quality of an image display device 420. For example, in an embodiment, the total of the distances d1, d2, and d3 is 38.33 millimeters, for example, the distance d4 is 16.5 millimeters, for example, and a ratio of the total of the distances d1, d2, and d3 to the distance d4 is about 2.3. The distances and the ratio thereof described above merely serve as an example. It should be understood that the invention is not limited thereto.

Besides, the descriptions of the embodiments shown in FIGS. 1 and 2 have provided sufficient teaching, suggestions, and explanations for embodiment concerning the locations and operations of the respective components in the head-mounted display 400 of this embodiment. Thus, details in these regards will not be reiterated below.

FIG. 4 is an optical schematic view illustrating an image display device according to an embodiment of the invention. FIG. 5 is an optical schematic view illustrating a light source module according to an embodiment of the invention. Referring to FIGS. 4 and 5, an image display device 300 includes the light source module 310, an image output element 326, a lens module 330 and an imaging element 328. In this embodiment, the lens module 330 is disposed between the image output element 326 and the imaging element 328 on the transmitting path of the image beam L2. The lens module 330 includes one or more lens elements, one or more mirror elements, and a combination thereof, for example. The invention does not intend to impose a limitation on the types of optical elements included in the lens module 330.

In this embodiment, the light source module 310 includes a light emitting element 322, a lens element 312, a light transmitting element 324, and a light collimating element 314. In this embodiment, the lens element 312 is disposed between the light emitting element 322 and the light transmitting element 324 on a transmitting path of the illumination beam L1. The light collimating element 314 is disposed between the light transmitting element 324 and the image output element 326 on the transmitting path of the illumination beam L1.

Specifically, in this embodiment, the light emitting element 322 provides the illumination beam L1 that the image output element 326 needs, and outputs the illumination beam L1 to the lens element 312. The lens element 312 focuses the illumination beam L1 on the light transmitting element 324. The light transmitting element 324 transmits the illumination beam L1 from the lens element 312 to the light collimating element 314. Then, the light collimating element 314 collimates the illumination beam and transmits the collimated illumination beam L1 to the image output element 326.

The image output element 326 outputs the image beam L2 to the lens module 330 based on the illumination beam L1. The lens module 330 then focuses the image beam L2 on the imaging element 328. The imaging element 328 projects the image beam L2 to the projection target 800, so as to display the image. The projection target 800 is the user's eye, for example.

In this embodiment, the lens element 312 and the lens elements included in the lens module 330 may be a variety of lens elements or a combination thereof, such as a lens, a mirror, a curve mirror, a prism, a mirror-prism, a mirror-lens, or a prism-lens. The invention does not intend to impose a limitation on the types of the lens element 312 and the lens module 330.

In this embodiment, the light transmitting element 324 may be a wave guide, an optical fiber, an integral rod, a light pipe, or the like, for example, and the invention does not intend to impose a limitation on the types of the light transmitting element 324. In this embodiment, the light collimating element 314 is disposed between the light transmitting element 324 and the image output element 326 to adjust a distribution of a light shape of the illumination beam L1 when the illumination beam L1 enters the image output element 326, so that at least the distribution of the light shape of the illumination beam L1 output by the light transmitting element 324 meets a requirement of the image output element 326. The light collimating element 314 may be a Fresnel lens, a liquid crystal lens, or a gradient reflective index (GRIN) lens, for example. However, the invention does not intend to impose a limitation on the types of the light collimating element 134. Here, an area of the image output element 326 irradiated by the collimated illumination beam L1 provided by the light collimating element 314 is greater than an effective light emitting area of the image output element 326. The effective light emitting area of the of the image output element 326 here refers to an area where the image output element 326 adjusts the illumination beam L1, such as a liquid crystal adjustable area in a liquid crystal panel. The image output element 326 may be a light modulating device such as a digital micromirror device (DMD), or liquid crystal on silicon (LCoS), for example.

In this embodiment, the imaging element 328 is configured to change a traveling direction of the image beam L2 received from the lens module 330 to transmit the image beam L2 to the projection target 800 without completely reflecting the ambient beam L3. In this way, the user is able see the image of the surrounding in perspective. In this embodiment, the imaging element 328 is an optical element such as a transreflective optical element, a curve half-mirror, a liquid crystal lens, a diffraction component, a holography component, a Fresnel lens, or the like. The invention does not intend to impose a limitation on the type of the imaging element 328.

In this embodiment, the image display device 300 is disposed on the corresponding apparatus body in a way similar to that shown in the head-mounted display 100, 200, or 400 in FIG. 1, 2, or 3. Besides, the descriptions of the embodiments shown in FIGS. 1, 2, and 3 have provided sufficient teaching, suggestions, and explanations for embodiment concerning the locations and operations of the respective components in the image display device 300 of this embodiment. Thus, details in these regards will not be reiterated below.

In view of the above, the embodiments of the invention at least have one of the following advantages or effects. In the image display device according to the embodiments of the invention, the respective optical components are disposed dispersedly on the apparatus body. Such configuration may reduce the crowdedness caused by a collective arrangement of the respective optical components on the apparatus body, and the weights of the components are also shared by different parts of the user. Thus, the weight of the head-mounted display is evenly distributed, thereby making the heat-mounted display comfortable to wear. In addition, since the imaging element is integrated onto the lens of the spectacles or located at the inner side of the lens and tightly attached to the lens, the appearance of the head-mounted display is fashionable, and the awkwardness is significantly reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A head-mounted display, comprising:
an apparatus body comprising a first part and a second part connected to the first part; and
an image display device disposed in the apparatus body, configured to project an image to a projection target, and wherein the image display device comprises:
an image output element disposed in the first part of the apparatus body, and configured to output an image beam;
a plurality of lens elements disposed in the first part of the apparatus body; and
an imaging element disposed in the first part of the apparatus body, wherein the image output element outputs the image beam transmitted to the imaging element through the lens elements, and the imaging element projects the image beam to the projection target to display the image, and the projection target is located on a reference plane, and a projection of the image output element on the reference plane is above the projection target.

2. The head-mounted display as claimed in claim 1, wherein the lens elements are disposed on a transmitting path of the image beam and located between the image output element and the imaging element.

3. The head-mounted display as claimed in claim 1, wherein the image display device further comprises a light source module configured to output an illumination beam to the image output element, the image output element outputs the image beam based on the illumination beam, the image beam is transmitted to the imaging element through the lens elements, and the imaging element projects the image beam to the projection target by virtual image projection to display the image,
wherein the light source module, the image output element, and the lens elements are disposed dispersedly in the first part of the apparatus body.

4. The head-mounted display as claimed in claim 1, wherein the image display device further comprises at least one mirror element configured to change a transmitting path of the image beam, and the at least one mirror element, the image output element, and the lens elements are disposed dispersedly in the first part of the apparatus body.

5. The head-mounted display as claimed in claim 4, wherein the at least one mirror element is disposed on the transmitting path of the image beam and located between the lens elements.

6. The head-mounted display as claimed in claim 4, wherein the lens elements comprise a first lens element, a second lens element, a third lens element, and a fourth lens element, the at least one mirror element comprises a first mirror element and a second mirror element, the first lens element, the second lens element, the third lens element, the first mirror element, the second mirror element, and the fourth lens element are on an optical axis and sequentially arranged in a direction from the image output element to the imaging element, wherein a distance between the third lens element and the first mirror element on the optical axis is d1, a distance between the first mirror element and the second mirror element on the optical axis is d2, a distance between the second mirror element and the fourth lens element on the optical axis is d3, and a distance between the imaging element and the projection target is d4, and a ratio of a total of the distances d1, d2, and d3 to the distance d4 is in a range from 2 to 2.5.

7. The head-mounted display as claimed in claim 1, wherein the imaging element is disposed in one of the first part and the second part of the apparatus body.

8. The head-mounted display as claimed in claim 1, wherein an ambient beam passes through the second part of the apparatus body and is projected to the projection target.

9. The head-mounted display as claimed in claim 1, wherein the apparatus body comprises spectacles, the second part comprises a lens, and the first part comprises at least one of a frame, a holder, and a nose pad.

10. The head-mounted display as claimed in claim 9, wherein the imaging output element is disposed in the frame, and the lens elements are disposed dispersedly in at least one of the frame and the nose pad.
